(19) United States
(12) Patent Application Publication
(10) Pub. No.: US 2003/0189329 A1
(43) Pub. Date: Oct. 9, 2003

(54) Combination hauling vehicle and low boy trailer and trailer with outrigger assembly

(76) Inventor: Francis V. Smith, Bozeman, MT (US)

Correspondence Address: CLARK & BRODY, 1750 K Street, NW, Suite 600, Washington, DC, 20006, US

(21) Appl. No.: 10/271,587

(22) Filed: Oct. 17, 2002

Related U.S. Application Data
(60) Provisional application No. 60/369,314, filed on Apr. 3, 2002.

(51) Int. Cl. B60R 1/00

(52) U.S. Cl. 280/762

(57) ABSTRACT

A combination hauling truck and lowboy trailer includes a trailer having a separate power unit and one or more powered axles. An additional powered axle can be added to the hauling truck. The lowboy trailer has outrigger assemblies associated with its rear tires. Tires of the outrigger assemblies move between operative positions for load carrying capability, and retracted positions for maintenance of trailer tires.

This application claims priority under 35 USC 119(e) based on provisional patent application number 60/369,314 filed on Apr. 3, 2002.

### FIELD OF THE INVENTION

The present invention is directed to the combination of a hauling vehicle and a low boy trailer, and a trailer that includes an outrigger assembly, and in particular, to a combination adapted to carry extremely heavy mining equipment, and an outrigger assembly that exposes the inner rear tires of the trailer for maintenance, while providing additional trailer support.

### BACKGROUND ART

In the field of hauling of extremely large and heavy equipment, particularly mining equipment, it is common to employ lowboy trailers. These trailers normally employ a gooseneck hitch and have a trailer bed positioned between the hitch and rear wheel. The trailer bed is normally positioned low to the ground to facilitate loading and unloading of equipment.

With the onset of bigger and bigger mining equipment, there is an ever-growing need for improved lowboy trailers. The present invention solves this need with an improved lowboy trailer that utilizes an outrigger assembly in conjunction with a set of rear wheels.

In the prior art, the use of outrigger assemblies on vehicles is well known. U.S. Pat. No. 4,133,402 to Hoo discloses an outrigger assembly for a two wheel motorized vehicle.

U.S. Pat. No. 5,029,895 to Anderson shows another type of outrigger assembly wherein the wheel of the outrigger is raised vertically in a plane coinciding with the wheel itself.

U.S. Pat. No. 4,576,390 to Vos shows the use of an outrigger assembly that is employed for dump trucks and the like.

However, none of this prior art suggests all of the features of the present invention.

### SUMMARY OF THE INVENTION

It is a first object of the present invention to provide an improved lowboy trailer.

Another object of the invention is to provide an improved lowboy trailer that allows rear wheels to be easily and efficiently maintained.

A further object is a method of accessing rear wheels on a lowboy trailer for maintenance purposes and the like using an outrigger assembly.

A still further object of the invention is a lowboy trailer adapted for moving extremely heavy equipment, such as 1200 ton mining shovels.

One aspect of the invention involves improvements in lowboy trailers that utilize a trailer bed positioned between a hitch and at least one axle and tire assembly supporting a rear portion of the lowboy trailer. The tire and axle assembly typically comprises at least one pair of trailer tires, a first trailer tire of the pair being separated from a second trailer tire of the pair by an axle structure. The invention provides improvement in these types of trailers by the addition of an outrigger assembly for each of the first and second trailer tires. Each outrigger assembly has an outrigger tire, and an outrigger tire lifting mechanism mounted to the trailer. Each outrigger tire wheel lifting mechanism is adapted to move its outrigger tire along an arc generally angled to a longitudinal axis of the lowboy trailer and between an operative position for supporting the trailer wherein each outrigger tire contacts a ground surface and a retracted position wherein arcuate movement of each outrigger tire exposes a face of an adjacent trailer tire for access thereto.

While the invention can use the one pair of trailer tires, another option is the use of one or two powered axle assembly instead of the one pair of trailer tires. Each powered axle assembly can employ four tires total, a set of two on each side of the trailer, each set separated by an axle. The power unit can be mounted on the trailer. When using two powered axle assemblies, one can be rigidly mounted to the trailer frame with other assembly being suspension-mounted to either the one powered axle assembly or the trailer frame

In one mode, the trailer can have a first plurality of main rails extending from the front portion to a rear portion of the trailer, and a second plurality rails extending along a trailer main bed portion only.

Each outrigger lifting mechanism can comprise a pivot arm assembly with first, second and third ends, the first end connected to the outrigger wheel, the second end pivotally connected to the trailer, and the third end connected to a hydraulic drive, movement of a piston of the hydraulic drive moving the pivot arm assembly between the operative and retracted positions. Both the pivot arm assembly and hydraulic drive can be connected to a support structure mounted to the trailer.

Another embodiment of the invention comprises a truck in combination with the lowboy trailer. In the embodiment, the lowboy trailer has a first power unit supplying power to a first pair of rear end-mounted powered axle assemblies. A hauling vehicle is provided with a second power unit supplying power to a second pair of powered axle assemblies. The lowboy trailer has mounted at its front end a hitching mechanism adapted to connect to the hauling vehicle. Power is supplied in series to the first pair of powered axle assemblies via the first power unit and supplied in series to the second pair of powered axle assemblies via the second power unit. Preferably, one of the first pair of the powered axle assemblies is mounted to the lowboy trailer, and the other of the pair is moveably mounted to either the lowboy-mounted powered axle assembly or the lowboy trailer. One of the second pair can be mounted to a frame of the hauling truck, and the other of the second pair is moveably mounted to either the frame-mounted powered axle assembly or the frame.

Another embodiment of the invention entails a method of exposing a trailer tire of a lowboy trailer for maintenance. The method comprises providing at least a pair of outrigger tire assemblies, each assembly comprising an outrigger tire and a tire lifting mechanism for moving the tire between an operative position and a retracted position. Each outrigger tire assembly is mounted to a rear portion of the lowboy trailer, with the outrigger tire of each assembly positioned adjacent a trailer tire. The tire lifting mechanism can be actuated so that each outrigger tire is lifted along an arcuate path that is angled to a longitudinal axis of the lowboy trailer so as to move the outrigger tire into the retracted position. With the outrigger tire retracted, the trailer tire adjacent thereto is exposed for maintenance. Once retracted, each outrigger tire can then be moved along the arcuate path and back into an operative position to assist in supporting a load on the lowboy trailer. The inventive method can be used in any of the embodiments of the trailer described above. The presence of the outrigger tires in the operative position prevents access to the trailer tire unless the outrigger tire is raised to its retracted position.

### BRIEF DESCRIPTION OF THE DRAWINGS

Reference is now made to the drawings of the invention wherein:

FIG. 1 shows a side view of the modified truck and lowboy trailer combination in use;

FIG. 2 is an enlarged side view of the modified truck and hitch of FIG. 1;

FIG. 3 is a top view of the combination negotiating a curve in a road;

FIG. 4 is an enlarged side view of the rear end of the lowboy trailer of FIG. 1;

FIG. 5 is an enlarged top view of the rear end of the lowboy trailer of FIG. 1; and

FIG. 6 is an enlarged rear view the rear end of the lowboy trailer of FIG. 1.

### DESCRIPTION OF THE PREFERRED EMBODIMENTS

The present invention offers significant advantages in the field of hauling mining equipment, particularly extremely heavy equipment such as mining shovels and the like. The invention provides a lowboy trailer and truck combination that is effective in hauling such heavy equipment. Further, the trailer employs an outrigger assembly that provides additional support for the equipment being hauled, and access to inner tires on the trailer for maintenance purposes.

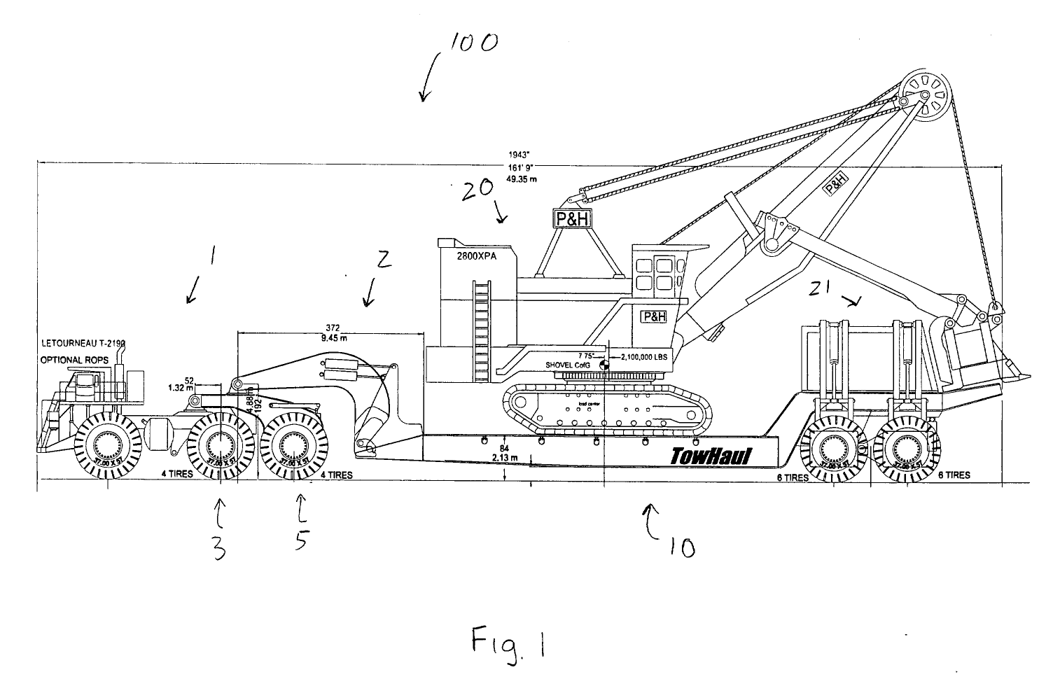

Referring now to FIG. 1, a modified lowboy trailer and truck combination is designated by the reference number 100. The lowboy trailer 10 of the combination is hauled by a modified mining truck 1, with the trailer 10 supporting a shovel 20. The trailer 10 is linked to the truck 1 via the gooseneck hitch assembly 2.

The gooseneck hitch assembly 2 is described in U.S. Pat. No. 5,435,586 to Smith, which is herein incorporated by reference in its entirety. This hitching assembly 2 interacts with the lowboy trailer for both trailer front end lifting for transport and front end lowering for loading or unloading of equipment. Since the Smith patent teaches the details of the gooseneck hitch assembly operation in conjunction with a lowboy trailer, a further explanation is not necessary for understanding of the invention.

The modified mining truck 1 can be made using a typical mining truck such as a 190 ton mine haul truck (a LeTourneau T2190) that has a powered rear tire and axle assembly 3. The truck 1 is modified with an additional jeep tag powered axle assembly 5, e.g., an axle from another LeTourneau truck. When using this truck as a source of the jeep tag axle assembly 5, the axle of the assembly has a preferred 30.7:1 ratio, and is complete with gears, traction motors, brake converters, wheel brakes and is adapted to mount to 37.0×50.0 tires.

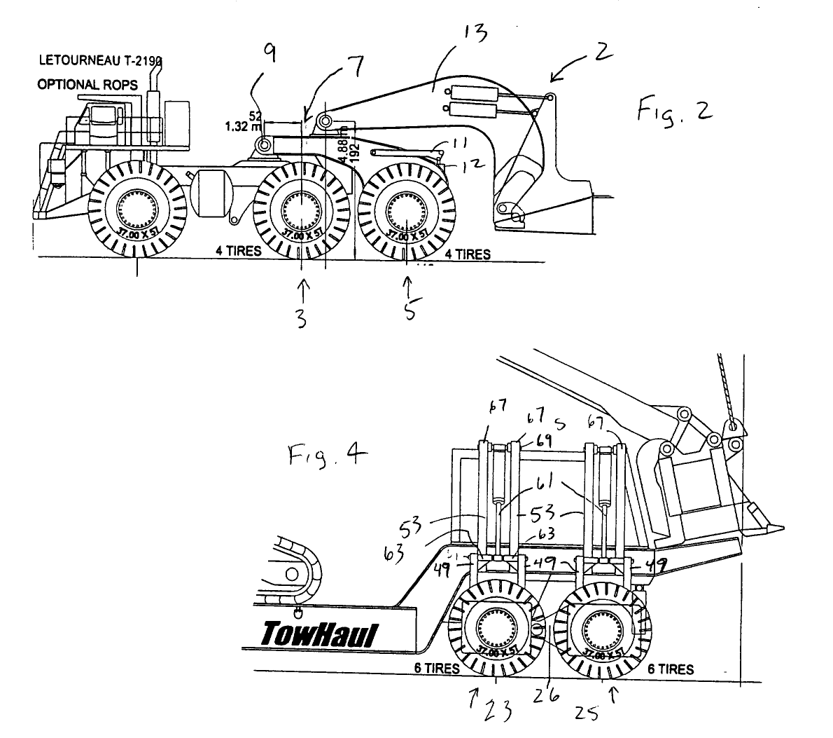

Referring to FIGS. 1 and 2, the jeep tag powered axle assembly 5 is mounted to a jeep tag frame 7 that is coupled to the truck body at 9. It is preferred that the coupling at 9 is configured so that oscillation of the jeep tag frame 7 and axle assembly 5 is in the vertical direction. However, other configurations could be employed to allow the axle assembly to move one or more desired directions with respect to the truck body 9. In another alternative, the axle assembly 5 could be mounted to the rigidly mounted axle assembly 3, rather than the truck frame.

The jeep tag frame 7 is also equipped with a hydraulically driven apron 11 which, when raised using hydraulic cylinders 12, is designed to support the gooseneck 13 of the hitch assembly 2 when the trailer 10 is not present.

The modified mining truck 1 serves as a primary mover for the trailer 10. However, power is also supplied by a lowboy power unit 21 mounted at the rear of the trailer 10. This power unit 21 can be supplied by using the powered unit from another LeTourneau mining truck as described below.

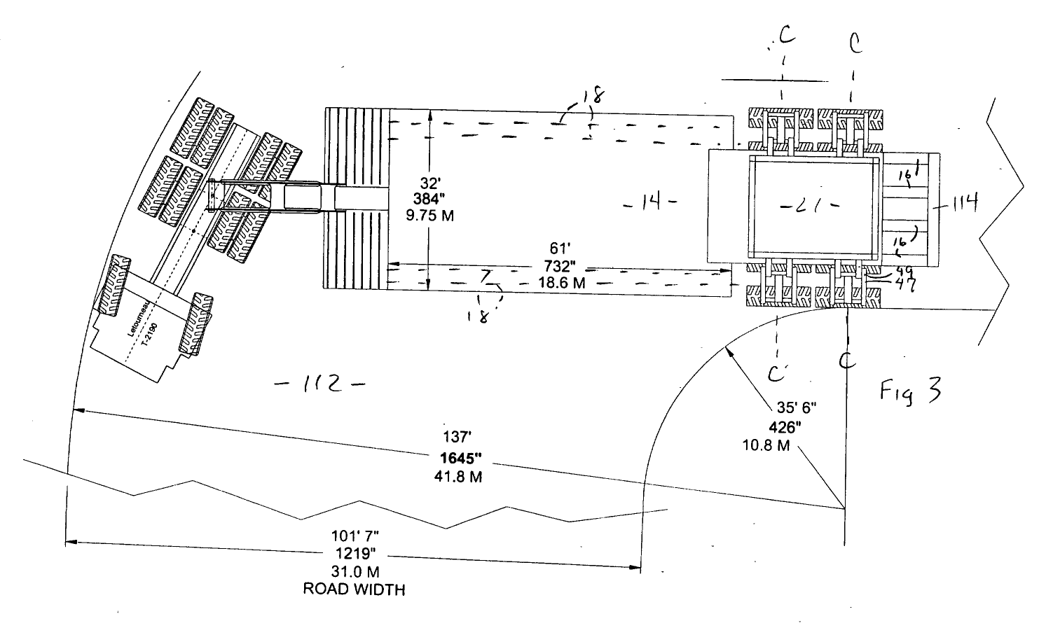

As shown in FIG. 2, the trailer 10 includes a main bed 14, preferably 6 inch fir decking, and a number of main rails 16, preferably made of T-1 steel. Preferably four center rails at full length are employed, plus four outer rails over the length of the trailer main bed 14. The four outer rails are represented by the hatch lines 18 in FIG. 3.

The gooseneck hitch assembly 2 attaches to a front end of the trailer as described in the aforementioned Smith patent.

The power unit 21 is mounted to a rear portion 22 of the trailer and drives a pair of powered axle assemblies 23 and 25. The powered axle 23 can come from the second mining truck whose power unit is used as the secondary mover of the equipment being moved. This first powered axle 23 can be directly mounted to the trailer frame, with the second powered axle 25 mounted behind the first axle and equipped with suspension struts 26 to permit axle oscillation. The second axle 25 can be moveably mounted to the first axle or to the lowboy trailer frame. This mounting contrasts with the direct attachment of the jeep tag axle assembly 5 to the jeep tag frame 7. The direct attachment is permitted since the jeep tag frame 7 oscillates rather than the jeep tag axle assembly 5. In order to have power equalization, the lowboy power unit 21 is slaved to the truck power unit using a PLC (programmable logic controller). A coaxial cable with a connector at the gooseneck hitch 2 can be employed to connect the two units. The two power units will be closely synchronized via the function of the electrical controls. With a gross weight of 3,203,160 lbs with a P&H shovel weighing 2,100,000 lbs, using two truck power units and, through four powered axles using eight motors, will result in the same performance as one truck at 800,970 lbs gross weight. Speed will be 50% of a single truck with a double powered axle. For an ascent grade of 10% actual and 2% rolling resistance (12% effective grade), the speed would be 2.5 mph. For an adverse 10% grade, less 2% rolling resistance (effective 8%), speed would be 5 mph. Retarding on an 8% effective grade with 30.7:1 gears is up to 9 mph. An empty unit should travel about 15 mph.

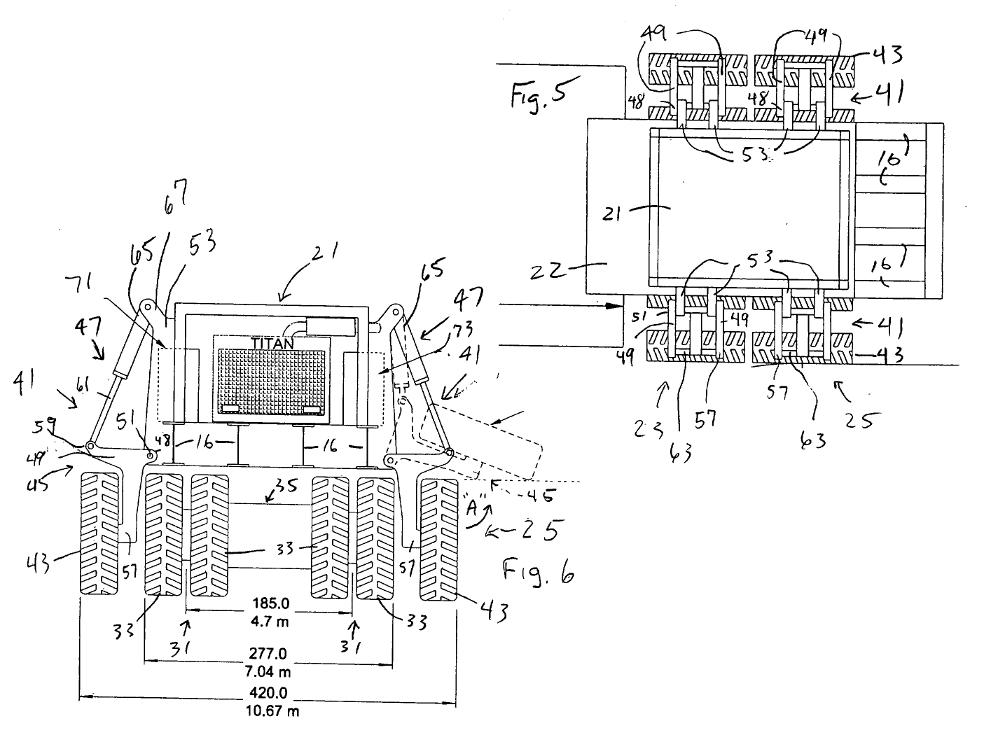

As best seen from FIGS. 5 and 6, each powered axle 23, 25 is equipped with four tires, two pairs of two adjacent tires.

FIG. 6 more clearly depicts the powered axle assembly 25 and outrigger assemblies 41. As noted above, the powered axle assembly 25 has two sets of tire pairs 31, the pairs 31 each having tires 33. The tire pairs 31 are separated by the motor assembly 35, power to the motors being supplied by the power unit 21. Since the manner of transferring power from the unit 21 to the motors and axles is well known, a further description is not deemed necessary for understanding of the invention.

Each outrigger assembly 41 is equipped with an outrigger tire 43, a pivot arm assembly 45, and a hydraulic drive 47.

Each pivot arm assembly 45 has a pair of arms 49, each end 48 of each arm 49 being pivotally mounted at 51 to a support member 53. Each support member 53 is mounted to the trailer 10.

Another end 57 of each of the pivot arms 49 is mounted the outrigger tire 43 using a spindle (not shown). The spindle can derive from the truck that is parted out to supply the power unit 21 and one of the powered axles 23 or 25, or can come from another source. In the instance where a parted out truck is used, two additional spindles are needed if four outrigger assemblies are to be utilized (the parted out truck only has two front tire spindles).

Another end 59 of each arm 49 is pivotally attached to a piston 61 of the hydraulic cylinder 65 of the drive 47 via pins 63, see FIG. 4.

An end of the cylinder 65 is linked to an end 67 of the support members 53 at 69, see FIG. 4.

The drive 47 controls the motion of the piston 61 so as to move the outrigger tire 43 to its desired position as follows. The operative position of all tires 43 is shown in FIGS. 3 and 5, and one tire in the retracted position is shown in FIG. 6. In the operative position, the outrigger tires 43 help support the trailer load in conjunction with the tire pairs 31.

As shown in phantom in FIG. 6, the outrigger tires 43 can be moved in a retracted position via movement of the piston 61 of the hydraulic drive 47. The piston 61 is retracted into the cylinder 65 via control of the hydraulic drive 47 such that the pivot arm 49 rotates about point 51 and the outrigger tire 43 follows the arcuate path “A”. The path “A” is generally in a direction transverse to a longitude of the trailer 10, or in the plane C shown in FIG. 3. Although not shown, the path “A” could be upward and toward the front of the trailer, or the rear of the trailer. In this mode, instead of following along a direction perpendicular to the longitudinal axis of the trailer, the arcuate path would be angled with respect to both the longitudinal and transverse directions.

When the outrigger tires 43 are in the retracted or raised position, the outer tire 33 of any given tire pair 31 is exposed so that the exposed tire 31 can be subject to maintenance, or removed so that the inner tire 31 is accessible. Raising of either of the outrigger tires 43 enables access to both of the tires in each pair 31, if necessary.

Also shown in FIG. 6 is the control box 71 for the outrigger assemblies 41 and power unit 21, and retarder stands 73 as are used for each of the powered axle assemblies 23 and 25. The control box 71 has the necessary control circuitry to operate the hydraulic drive for outrigger tire movement and load accommodation, as well as the power unit 21. The control box 71 can be derived from the parted out truck which also serves as the source for the power unit 21, one powered axle, and one retarder stand. Since the controls for operating the power unit and the hydraulic drive are conventional, a further explanation of this aspect of the invention is not necessary for understanding of the invention. The controls of the outrigger assembly are also designed to equalize their loads using load sensors and/or accumulators as are conventionally used in other hauling applications. Similarly, as explained below, the retarder stands are conventional for powered axles, but that according to the invention, each powered axle is now equipped with its own retarder stand.

FIG. 3 also shows a top view of the truck and trailer combination 100, and the ability for the combination 100 to negotiate a particular radiused bend in the road 112. This view also shows the rails 16 and end beam 114 extending beyond the power unit 21 to provide support for the bucket of the shovel.

While the drawings depict two powered axles supporting the rear portion of the trailer, the trailer could employ other types of tire and axle assemblies. For example, one powered axle assembly could be used that employs two pairs of tires, or four tires in total in combination with the outrigger tire mechanism. Alternatively, more than two powered axles could be employed with an additional power unit if necessary. It should be understood that the combination is preferred to have at least the outrigger assemblies, the two power units and four powered axles so that a load such as the depicted shovel can be transported. However, the outrigger assembly could be associated with differently configured lowboy trailers that employ powered rear axles, or non-powered rear axles, so that the inner tires can be accessed.

While the lowboy trailer 10 can be sized to carry a variety of loads, the depicted trailer is primarily designed to have a 1200 ton capacity so as to carry electric shovels like the one depicted in FIG. 1. Other types of shovels include P&H 2800 XP, 2300 XP, and 2100 BLE, and B-E 290 electric shovels.

As noted above, it is preferred that existing truck components be used. This provides gradeabilities comparable to a fully loaded T-2190 truck at one half speed. Since power is proportional to speed times torque, the inventive combination is four times as heavy as the truck and has twice the power. Thus, in theory, it is possible to negotiate a given grade at one half speed providing that adequate torque control is delivered. In other words, four times the total torque of a fully loaded T-2190 truck is required. This is achieved by using the two power units, one power unit in the mining truck 1 and the other being the power unit 21. Each unit is modified to deliver twice its normal torque capability at the same armature currents.

Each power unit has two armature converters that deliver high current with resultant high torque at low speed. This same current passing through two armatures in series can deliver twice as much torque for the same amount of current but at a lower speed of approximately 50%. Higher torque at lower speed for the same horsepower is obtained.

Because of the additional powered axle for each power unit, the cooling system should be upgraded to cool the motors of each additional powered axle. Air can be supplied to all four traction motors per power unit using an electric high pressure blower, e.g., a 50-75 HP blower. The blower is powered via an AC motor and a transformer from the main generator.

In some prior art hauling trucks (see U.S. Pat. No. 4,719,361 to Brubaker, herein incorporated by reference), one armature converter and one motor field converter are associated with the truck's power unit. Other hauling trucks may use pairs of armature converters and motor field converters.

When using a truck employing pairs of armature converters and pairs of motor field converters, the pair of armature converters are in series, so that each armature converter supplies two armatures in series. With the truck using a pair of motor field converters, this pair is also in series, with the pair supplying four motor fields in series.

The prior art trucks useful for the invention also employ one motor field converter for powering two existing motor fields in series. This field converter can be modified/rebuilt to accommodate the two extra fields that result from the additional powered axle for each power unit, or an additional field converter can be utilized. Modification of the existing field converter to supply the two extra fields is within the skill of the artisan and does not require further explanation.

Each truck also comes with a retarder stand for each powered axle. Since there are two additional powered axles, an additional complete retarded stand is employed for each power unit to accept power from the additional two traction motors per power unit. The retarder stands provide for the traction motors to generate against the generator/engine, thus overcoming engine parasitic losses. Long term fuel economy is enhanced as well.

As such, an invention has been disclosed in terms of preferred embodiments thereof which fulfills each and every one of the objects of the present invention as set forth above and provides a new and improved lowboy trailer and truck combination, and a method of use.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. In a lowboy trailer comprising a trailer bed positioned between a hitch and at least one axle and tire assembly supporting a rear portion of the lowboy trailer, the tire and axle assembly further comprising at least one pair of trailer tires, a first trailer tire of the pair being separated from a second trailer tire of the pair by an axle structure, the improvement comprising an outrigger assembly for each of the first and second trailer tires, each outrigger assembly comprising an outrigger tire, and an outrigger tire lifting mechanism mounted to the trailer, each outrigger tire wheel lifting mechanism adapted to move its outrigger tire along an arc generally angled to a longitudinal axis of the lowboy trailer and between an operative position for supporting the trailer wherein each outrigger tire contacts a ground surface and a retracted position wherein arcuate movement of each outrigger tire exposes a face of an adjacent trailer tire for access thereto.

2. The trailer of claim 1, wherein the at least one pair of trailer tires further comprises at least one powered axle assembly, the powered axle assembly having two sets of trailer tires and being powered by a power unit mounted on the trailer.

3. The trailer of claim 2, further comprising two powered axle assemblies.

4. The trailer of claim 1, wherein the trailer has a first plurality of main rails extending from a front portion to a rear portion of the trailer, and a second plurality rails extending along a trailer main bed portion only.

5. The trailer of claim 3, wherein the one powered axle assembly is rigidly mounted to the trailer frame and the other powered axle assembly is suspension-mounted to either the one powered axle assembly or the trailer frame.

6. The trailer of claim 1, wherein each outrigger lifting. mechanism further comprises a pivot arm assembly with first, second and third ends, the first end connected to the outrigger wheel, the second end pivotally connected to the trailer, and the third end connected to a hydraulic drive, movement of a piston of the hydraulic drive moving the pivot arm assembly between the operative and retracted positions.

7. The trailer of claim 6, wherein the pivot arm assembly and hydraulic drive are both connected to a support structure mounted to the trailer.

8. A truck and lowboy combination comprising:
a lowboy trailer having a first power unit supplying power to a first pair of rear end-mounted powered axle assemblies;
a hauling vehicle having a second power unit supplying power to a second pair of powered axle assemblies; and
a hitching assembly mounted at a front end of the lowboy trailer adapted to connect to the hauling vehicle;
wherein power is supplied in series to the first pair of powered axle assemblies via the first power unit and supplied in series to the second pair of powered axle assemblies via the second power unit.

9. The combination of claim 8, wherein one of the first pair of the powered axle assemblies is mounted to the lowboy trailer, and the other of the pair is moveably mounted to either the lowboy-mounted powered axle assembly or the lowboy trailer.

10. The combination of claim 8, wherein one of the second pair is mounted to a frame of the hauling truck, and the other of the second pair is moveably mounted to either the frame-mounted powered axle assembly or the frame.

11. A method of exposing a trailer tire of a lowboy trailer for maintenance comprising:
providing at least a pair of outrigger tire assemblies, each assembly comprising an outrigger tire and a tire lifting mechanism for moving the tire between an operative position and a retracted position, each outrigger tire assembly mounted to a rear portion of the lowboy trailer, with the outrigger tire of each assembly positioned adjacent a trailer tire;
actuating each lift mechanism so that each outrigger tire follows an arcuate path that is angled to a longitudinal axis of the lowboy trailer into the retracted position so that each trailer tire is exposed; and
moving each outrigger tire along the arcuate path and back into an operative position to assist in supporting a load on the lowboy trailer.

12. The method of claim 11, wherein the lowboy trailer comprises the trailer of claim 1.

13. The method of claim 11, comprising each outrigger tire positioned adjacent each trailer tire such that an outer side of the trailer tire cannot be accessed for maintenance without the adjacent outrigger tire being moved to the retracted position.

14. The trailer of claim 5, wherein each outrigger lifting mechanism further comprises a pivot arm assembly with first, second and third ends, the first end connected to the outrigger wheel, the second end pivotally connected to the trailer, and the third end connected to a hydraulic drive, movement of a piston of the hydraulic drive moving the pivot arm assembly between the operative and retracted positions.

15. The combination of claim 9, wherein one of the second pair is mounted to a frame of the hauling truck, and the other of the second pair is moveably mounted to either the frame-mounted powered axle assembly or the frame.
